(19) United States
(12) Patent Application Publication
(10) Pub. No.: US 2025/0110554 A1
(43) Pub. Date: Apr. 3, 2025

(54) INFORMATION PROCESSING SYSTEM, INFORMATION PROCESSING APPARATUS, AND INFORMATION PROCESSING METHOD

(71) Applicant: GEOCREATES, INC., Tokyo (JP)

(72) Inventor: Tsukasa Honda, Tokyo (JP)

(21) Appl. No.: 18/953,216

(22) Filed: Nov. 20, 2024

Related U.S. Application Data
(63) Continuation of application No. PCT/JP2023/019075, filed on May 23, 2023.

(30) Foreign Application Priority Data
May 26, 2022 (WO) PCT/JP2022/021503

(51) Int. Cl. G06F 3/01; G06T 19/00; G06V 10/62

(52) U.S. Cl. CPC G06F 3/013; G06T 19/003; G06V 10/62

(57) ABSTRACT

The information processing apparatus includes a data acquisition part that acquires display state data for identifying the virtual space image viewed by the user, a gazing identification part that identifies a gazing time point at which the user gazes at least at a portion of the virtual space image for a predetermined time or longer, a feature identification part that identifies a feature manifestation time point that is a point in time at which a specific feature is included in the virtual space image displayed on the information terminal, and an output part that outputs the gazing time point and the feature manifestation time point in association with each other.

### CROSS-REFERENCE TO RELATED APPLICATIONS

The present application is a continuation application of International Application number PCT/JP2023/019075, filed on May 23, 2023, which claims priority under 35 U.S.C § 119(a) to International Application number PCT/JP2022/021503, filed on May 26, 2022, contents of which are incorporated herein by reference in their entirety.

### BACKGROUND OF THE INVENTION

The present disclosure relates to an information processing system, an information processing apparatus, and an information processing method.

Conventionally, a system that outputs information indicating a response of a user who views an image of a virtual reality space or an augmented reality space (hereinafter, referred to as a “virtual space image”) is known (see, for example, International Publication No. WO2020/032339).

In a conventional system, information indicating a change in a response of a user while viewing a virtual space image can be outputted. A designer or provider of a virtual space image (hereinafter, referred to as a “designer or the like”) can improve the virtual space image by grasping a change in the response of the user. However, it is difficult for a designer and the like to recognize what specific features in the virtual space image will elicit a particular response from the user simply by grasping changes in the user's reaction. Accordingly, there is a problem that it is difficult for the designer and the like to grasp how to modify the virtual space image.

### BRIEF SUMMARY OF THE INVENTION

The present disclosure focuses on this point, and an object thereof is to facilitate improvement of a virtual space image by a designer or the like of a virtual space image.

An information processing system of a first aspect of the present disclosure includes an information terminal, and an information processing apparatus that is capable of communicating with the information terminal, wherein the information terminal includes an operation receiving part that receives an operation of a user, and a display processing part that displays a virtual space image by changing a displayed region and a displaying orientation of virtual space image data provided from the information processing apparatus, on the basis of an operation of the user received by the operation receiving part, and the information processing apparatus includes a data acquisition part that acquires display state data for identifying the virtual space image viewed by the user, a gazing identification part that identifies a gazing time point at which the user viewing the virtual space image gazes at least at a portion of the virtual space image for a predetermined time or longer, on the basis of the display state data, a feature identification part that identifies a feature manifestation time point that is a point in time at which a specific feature is included in the virtual space image displayed on the information terminal, and an output part that outputs the gazing time point and the feature manifestation time point in association with each other.

An information processing device of a second aspect of the present disclosure includes a data acquisition part that acquires display state data for identifying a virtual space image, viewed by a user, in which a displayed region and a displaying orientation are changed by an operation of the user, a gazing identification part that identifies a gazing time point at which the user gazes at least at a portion of the virtual space image for a predetermined time or more, a feature identification part that identifies a feature manifestation time point that is a point in time at which specific feature is contained in the virtual space image displayed on the information terminal used by the user, and an output part that outputs the gazing time point and the feature manifestation time point in association with each other.

An information processing method, executed by a computer, of a third aspect of the present disclosure includes the steps of acquiring display state data for identifying a virtual space image, viewed by a user, in which a displayed region and a displaying direction are changed by an operation of the user, identifying a gazing time point at which the user gazes at least at a portion of the virtual space image for a predetermined time or longer, identifying a feature manifestation time point at which specific feature is contained in the virtual space image displayed on the information terminal used by the user, and outputting the gazing time point and the feature manifestation time point in association with each other.

### BRIEF DESCRIPTION OF THE DRAWINGS

FIG. 1 shows an overview of an information processing system S.

FIGS. 2A and 2B schematically show entire virtual space image data.

FIGS. 3A to 3C show an example of a virtual space image viewed by a user U.

FIG. 4 shows a configuration of an information terminal 1.

FIG. 5 shows a configuration of an information processing apparatus 2.

FIG. 6 shows an example of a screen including information outputted by the output part 234.

FIG. 7 shows an example of a screen on which an estimation result of a biological state is displayed.

FIGS. 8A to 8C show an example of an image in which a gazing time point (broken line) and a point in time (solid line) at which a specific feature is included are shown in time series for different viewing durations.

FIG. 9 shows an overview of an information processing system S1.

FIGS. 10A and 10B show an example of a screen displayed on the information terminal 1.

FIG. 11 shows a configuration of the information terminal 1.

FIG. 12 shows an example of recommended state data.

FIG. 13 shows an example of the recommended state data.

FIG. 14 shows a configuration of the information processing apparatus 2.

FIG. 15 is a sequence diagram illustrating an example of processing in the information processing system S1.

FIG. 16 shows an overview of the information processing system S2.

FIG. 17 shows a configuration of the information processing apparatus 4.

### DETAILED DESCRIPTION OF THE INVENTION

Hereinafter, the present disclosure will be described through exemplary embodiments of the present disclosure, but the following exemplary embodiments do not limit the disclosure according to the claims, and not all of the combinations of features described in the exemplary embodiments are necessarily essential to the solution means of the disclosure.

### First embodiment

### [An Overview of Information Processing System S]

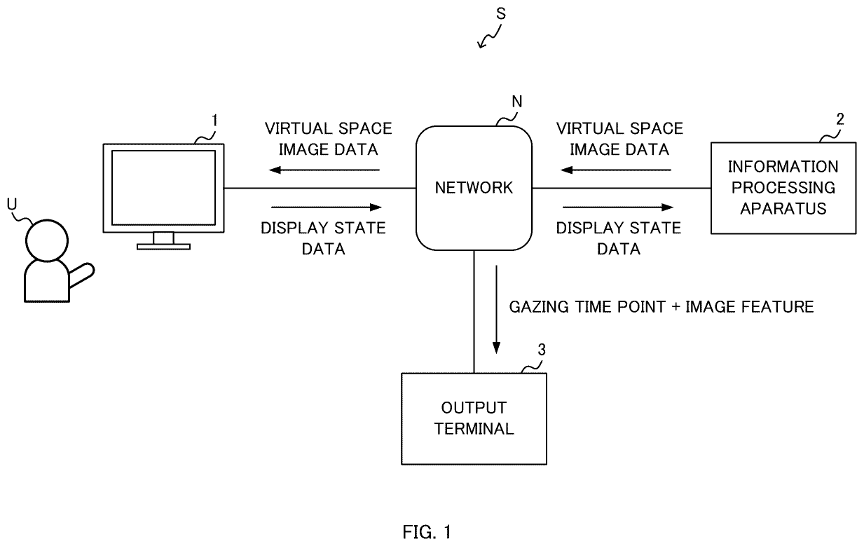

FIG. 1 shows an overview of an information processing system S. The information processing system S is a system for presenting a virtual space image to a user U so that a designer or the like of virtual space image data can grasp i) a point in time when the user U gazes while viewing the virtual space image and ii) a point in time at which a specific feature is contained in the virtual space image viewed by the user U. The specific feature of the virtual space image is at least one of i) a specific composition (for example, a single-point perspective composition or a two-point perspective composition) is included in the virtual space image, ii) an image of a specific object is included in the virtual space image, iii) route guidance information is included in the virtual space image, or iv) a ratio of a specific color in the virtual space image is equal to or greater than a threshold value.

The virtual space image data is image data representing a three-dimensional space generated by computer graphics, for example, but the virtual space image data may include image data generated by photographing a real object. Further, the virtual space image data may include augmented reality image data.

The virtual space image data is configured so that, for example, when the user U operates a terminal on which the virtual space image is displayed, a region displayed changes. That is, the virtual space image data corresponds to a region larger than an image region that can be displayed on the terminal used by the user U. The virtual space image data is image data that virtually represents a space in which the user U can move the position to be viewed, such as, for example, an event venue, a cityscape, or the interior of a building.

As an example, if the virtual space image data shows a space of an event venue, an organizer of the event, who is a provider of the virtual space image data, wants to have the user U see as many regions as possible. For example, if the organizer of the event wants to advertise a product, the organizer wants the user U to move to the region providing an explanation of the product. However, depending on the structure of the virtual space image data, the user U may cease from viewing the virtual space image because the user U does not know which direction to go or loses interest halfway through.

The information processing system S outputs i) the point in time when the user U gazes while viewing the virtual space image and ii) the feature of the virtual space image that changes while being viewed by the user U, making it easier for the designer or the like of the virtual space image data to grasp which feature of the virtual space image the user U gazes at. In addition, the information processing system S can also output information indicating a point in time at which the user U ends viewing the virtual space image, in association with information indicating the time point at which the user U gazes at the virtual space image and information indicating the feature of the virtual space image.

By looking at these pieces of information, the designer or the like can grasp what kind of configuration of the virtual space image makes it more likely for the user U to end viewing and what kind of configuration makes it more likely for the user U to continue viewing. As a result, it facilitates the designer or the like of the virtual space image to improve the virtual space image data.

The overview of the information processing system S will be described with reference to FIG. 1 below. The information processing system S includes an information terminal 1, an information processing apparatus 2, and an output terminal 3. The information terminal 1, the information processing apparatus 2, and the output terminal 3 are connected to the network N, and can transmit and receive data to and from other devices.

The information terminal 1 is a terminal used by the user U to view a virtual space image, and is a personal computer, a tablet, a smartphone, or a spectacle-shaped or goggle-shaped terminal, for example. The information terminal 1 displays a virtual space image based on virtual space image data received from the information processing apparatus 2 via the network N, on the display.

The information terminal 1 changes the position and orientation of the virtual space image to be displayed on the display among the virtual space image data, on the basis of the operation of the user U. The information terminal 1 transmits, to the information processing apparatus 2, display state data indicating the position and orientation of a region of the virtual space image, in the virtual space image data, displayed on the display. The display state data is data, for example, containing information indicating the position displayed by the information terminal 1 in the spatial image data and the orientation of the user U, which is associated with the timing. The display state data may be data obtained by taking a shot of a screen of the information terminal 1 displaying the virtual space image. In this case, the screen shot data is associated with the timing. It should be noted that the timing is represented by an elapsed time from when the user U starts viewing the virtual space image, for example.

The position in the virtual space image data is represented by three-dimensional coordinates or two-dimensional coordinates based on the origin of the three-dimensional space represented by the virtual space image data. The origin of the three-dimensional space is, for example, a position where the user U starts viewing the virtual space image (that is, a position from where the user U starts to proceed). The position in the virtual space image data is, for example, coordinates of the virtual space image data corresponding to the center position of the display.

The virtual space image data may include, as metadata, specific information included in the virtual space image data or coordinates indicating the position of a specific object. Said metadata includes coordinates of a position where guidance information such as a sign or an advertisement is displayed, for example. Said metadata may include coordinates of a position where the object is displayed, in association with the type of the object.

The orientation in the virtual space image data is represented by an orientation with respect to a reference orientation of the three-dimensional space represented by the virtual space image data. The reference orientation is an orientation of the virtual space image displayed on the display before the user U performs an operation for changing the displayed position and the orientation of the virtual space image, for example.

The information processing apparatus 2 provides the virtual space image data to the information terminal 1. Further, the information processing apparatus 2 outputs the time point at which the user U gazes and the feature in the virtual space image viewed by the user U in association with each other, on the basis of the display state data received from the information terminal 1. The information processing apparatus 2 outputs information indicating i) a gazing time point and ii) a time point when a virtual space image including the specific feature is displayed, to the output terminal 3 via the network N, for example.

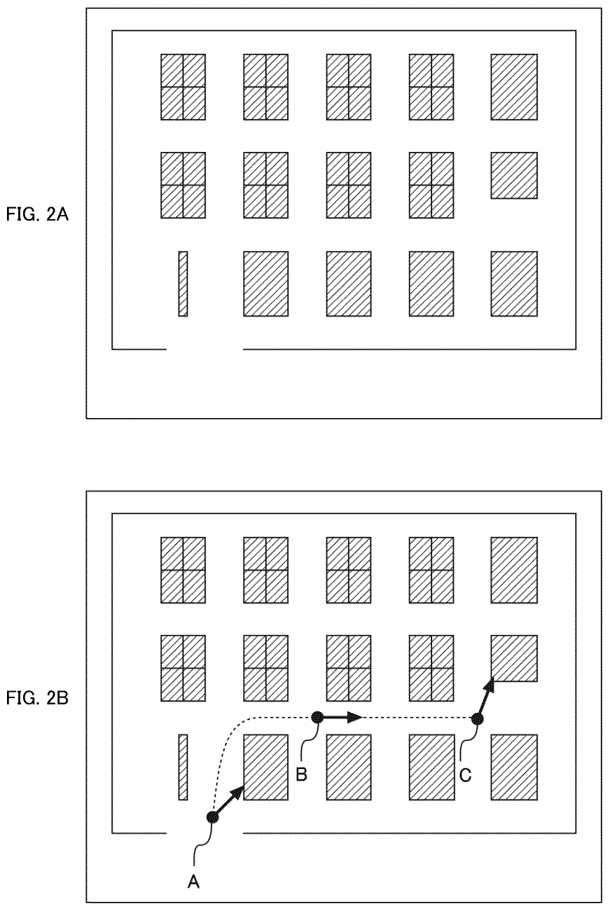

FIGS. 2A and 2B schematically show entire virtual space image data. The virtual space image data shown in FIG. 2A shows a layout of an event venue viewed from above. Hatched regions in FIGS. 2A and 2B are buildings, signage, and the like. FIG. 2B shows that the user U moves in the event venue along a route indicated by a broken line in accordance with the operation of the user U.

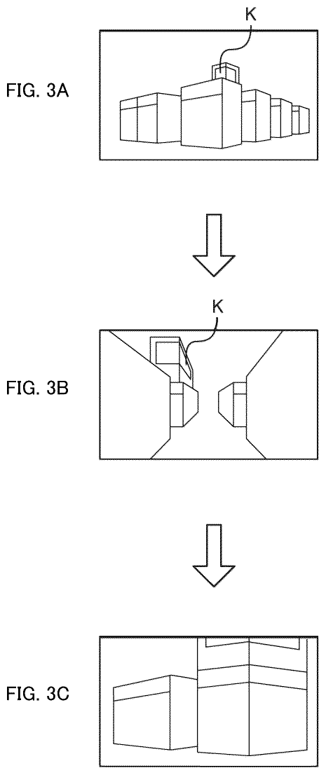

FIGS. 3A to 3C show an example of the virtual space image viewed by the user U. FIG. 3A is the virtual space image viewed by the user U in a state where the user U faces a direction of an arrow at a point A in FIG. 2B. FIG. 3B is the virtual space image viewed by the user U in a state where the user U faces a direction of an arrow at a point B in FIG. 2B. FIG. 3C is the virtual space image viewed by the user U in a state where the user U faces a direction of an arrow at a point C in FIG. 2B.

An object labeled with a reference sign K in FIG. 3B is an example of the guidance information indicating the direction of progression to the user U. The object labeled with the reference sign K contains information indicating the content of an event being held at a location in the direction toward that object or information indicating the direction in which the user U should proceed, for example.

### [Configuration of Information Terminal 1]

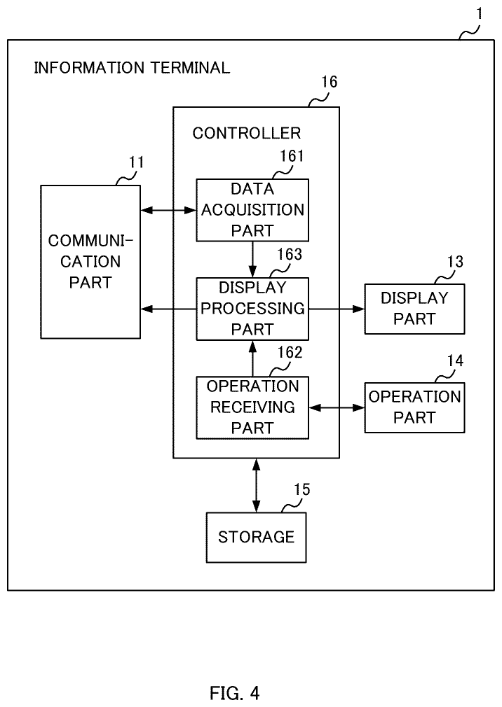

FIG. 4 shows a configuration of an information terminal 1. The information terminal 1 includes a communication part 11, a display part 13, an operation part 14, a storage 15, and a controller 16. The controller 16 includes a data acquisition part 161, an operation receiving part 162, and a display processing part 163.

The communication part 11 has a communication interface for transmitting and receiving data to and from the information processing apparatus 2 via the network N. The communication part 11 receives the virtual space image data transmitted from the information processing apparatus 2, and inputs the received virtual space image data to the data acquisition part 161, for example. Further, the communication part 11 acquires display state data indicating the position and orientation of the virtual space image displayed on the display part 13 from the display processing part 163, and transmits the display state data to the information processing apparatus 2 in association with the timing. The communication part 11 may transmit data obtained by taking a screen shot of the virtual space image displayed on the information terminal 1 as the display state data, in association with the timing.

The display part 13 is a display that displays various kinds of information. The display part 13 displays a virtual space image based on the virtual space image data, for example.

The operation part 14 is a device that receives an operation of the user U, and includes a keyboard and a mouse, for example. The operation part 14 inputs data indicating the content of the user U's operation to the operation receiving part 162.

The storage 15 includes a storage medium such as a Read Only Memory (ROM), a Random Access Memory (RAM), and a Solid State Drive (SSD). The storage 15 stores a program executed by the controller 16. Further, the storage 15 temporarily stores the virtual space image data, the display state data, and the like. For example, the storage 15 stores the display state data in association with an elapsed time from when the user U starts viewing the virtual space image.

The controller 16 includes a Central Processing Unit (CPU). The controller 16 functions as the data acquisition part 161, the operation receiving part 162, and the display processing part 163 by executing the program stored in the storage 15.

The data acquisition part 161 acquires the virtual space image data transmitted from the information processing apparatus 2. The data acquisition part 161 stores the acquired virtual space image data in the storage 15. The data acquisition part 161 may input the acquired virtual space image data to the display processing part 163.

The operation receiving part 162 receives an operation of the user U performed on the operation part 14. Specifically, the operation receiving part 162 receives coordinates indicating a position on the display part 13 touched by the user U or clicked by a mouse while the virtual space image is displayed on the display part 13, as the content of the user U's operation, for example.

The display processing part 163 causes the display part 13 to display the virtual space image based on the virtual space image data. The display processing part 163 changes the displayed region and the displaying orientation of the virtual space image data provided from the information processing apparatus 2 on the basis of the user U's operation received by the operation receiving part 162, thereby displaying the virtual space image corresponding to a portion of the virtual space image data, for example.

### [Configuration of Information Processing Apparatus 2]

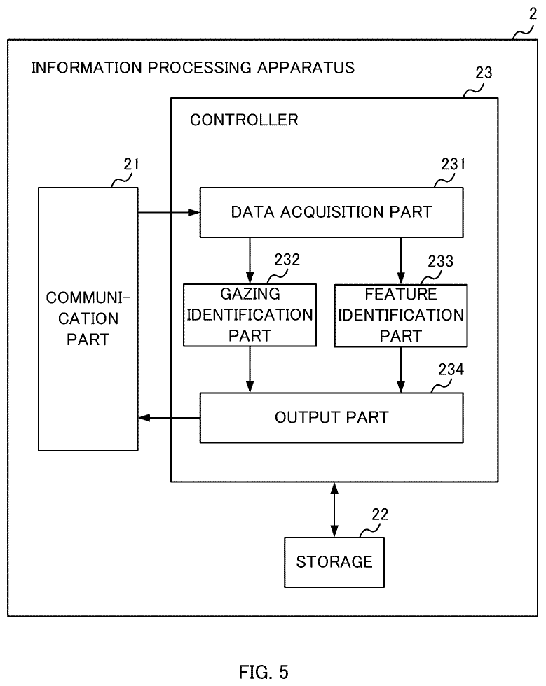

FIG. 5 shows a configuration of the information processing apparatus 2. The information processing apparatus 2 includes a communication part 21, a storage 22, and a controller 23. The controller 23 includes a data acquisition part 231, a gazing identification part 232, a feature identification part 233, and an output part 234.

The communication part 21 has a communication interface for transmitting and receiving data to and from the information terminal 1 and the output terminal 3 via the network N. The communication part 21 inputs the received data to the data acquisition part 231. In addition, the communication part 21 transmits the data inputted from the output part 234.

The storage 22 includes a storage medium such as a ROM, a RAM, and an SSD. The storage 22 stores a program executed by the controller 23. Further, the storage 22 stores the virtual space image data. The storage 22 stores the display state data acquired by the data acquisition part 231 via the communication part 21 in association with the user U.

The controller 23 includes a CPU, and functions as the data acquisition part 231, the gazing identification part 232, the feature identification part 233, and the output part 234 by executing the program stored in the storage 22.

The data acquisition part 231 acquires the display state data for identifying the virtual space image viewed by the user U from the information terminal 1 via the communication part 21. The data acquisition part 231 stores the acquired display state data in the storage 22 in association with the user U. The data acquisition part 231 may store the display state data in the storage 22 in association with the elapsed time from when the user U starts viewing the virtual space image data. The data acquisition part 231 may acquire end data indicating that the user U has stopped viewing the virtual space image, from the information terminal 1.

The gazing identification part 232 identifies a gazing time point at which the user U, viewing the virtual space image, gazes at least at a portion of the virtual space image for a predetermined time or longer, on the basis of the display state data. The predetermined time is the minimum amount of time during which the user U is assumed not to move the virtual space image when the virtual space image in which the user U is showing interest is being displayed, and is 3 seconds, for example. The predetermined time may be a time that can be set by the designer or the like via an external device such as the output terminal 3, or may be a fixed time.

The gazing identification part 232 identifies that it is a point in time at which the user U is gazing if the user U remains in the same position in the same orientation for a predetermined period of time, by comparing the position and orientation indicated by the plurality of pieces of display state data corresponding to a plurality of times of day. In a case where the display state data is image data obtained by taking a screen shot in the information terminal 1, the gazing identification part 232 identifies that it is a point in time at which the user U is gazing at the virtual space image if a plurality of pieces of screen shot data corresponding to a plurality of times of day are the same over the specific period of time.

The gazing identification part 232 may identify a position in the virtual space image data at which the user U gazes. For example, the gazing identification part 232 identifies the center position of the virtual space image displayed on the information terminal 1 at the time identified to be the gazing time point, as the position at which the user U gazes. If the information terminal 1 has a function of detecting the line of sight of the user U, the gazing identification part 232 may identify the position of the line of sight of the user U detected by the information terminal 1 at the gazing time point as the position at which the user U gazes.

The gazing identification part 232 may identify a point in time at which the user U gazes at the guidance information. For example, the gazing identification part 232 identifies coordinates indicating the position of the guidance information by referring to the metadata of the virtual space image data, and identifies a point in time at which the guidance information is included within a predetermined range from the center position of the display of the information terminal 1 as a point in time at which the user U gazes at the guidance information. The predetermined range is a range within which the user U, viewing the display of the information terminal 1 from the front, can clearly see the guidance information. For example, it is a range with a radius of 5 cm from the central position.

If a plurality of pieces of guidance information are contained in the virtual space image, the gazing identification part 232 may identify the guidance information gazed at for a longer time, from among the plurality of pieces of guidance information. In a case where the virtual space image contains a plurality of pieces of guidance information, the gazing identification part 232 may identify one or more pieces of guidance information for which the gazing time is a threshold value or more as gazed guidance information.

The feature identification part 233 identifies a feature manifestation time point that is a point in time at which the specific feature is contained in the virtual space image displayed on the information terminal 1 used by the user U. For example, by analyzing the shape of the object included in the virtual space image indicated by the display state data, the feature identification part 233 identifies a point in time at which the composition of the virtual space image displayed on the information terminal 1 is a single-point perspective composition, as the feature manifestation time point. The feature identification part 233 may identify, as the feature manifestation time point, a point in time at which at least one of the type, the size, or the position of the guidance information, indicating a route that the user U can follow in the virtual space image, is contained.

The feature identification part 233 may identify the proportion of time during which each of the plurality of objects is displayed in the virtual space image displayed within a predetermined time including the gazing time point. The plurality of objects include a passage, an intersection, guidance information, a green region (for example, grass or tree leaves), a brown region (for example, tree trunks or branches), and landmarks, for example. This predetermined time is a time during which the user U continuously gazes at the same position, for example. This predetermined time may be a time from when the user U starts viewing the virtual space image to when the user U ends the viewing. This predetermined time may be a time from the gazing time point immediately before the time when the user U ends viewing the virtual space image to an end time point of viewing.

The output part 234 outputs the gazing time point identified by the gazing identification part 232 and the feature manifestation time point identified by the feature identification part 233 in association with each other. The output part 234 transmits information indicating the gazing time point and information indicating the feature manifestation time point to the output terminal 3 via the communication part 21, for example. The output part 234 may output information indicating the end time point of viewing indicated by the end data acquired from the information terminal 1 by the data acquisition part 231, in association with the gazing time point and the feature manifestation time point.

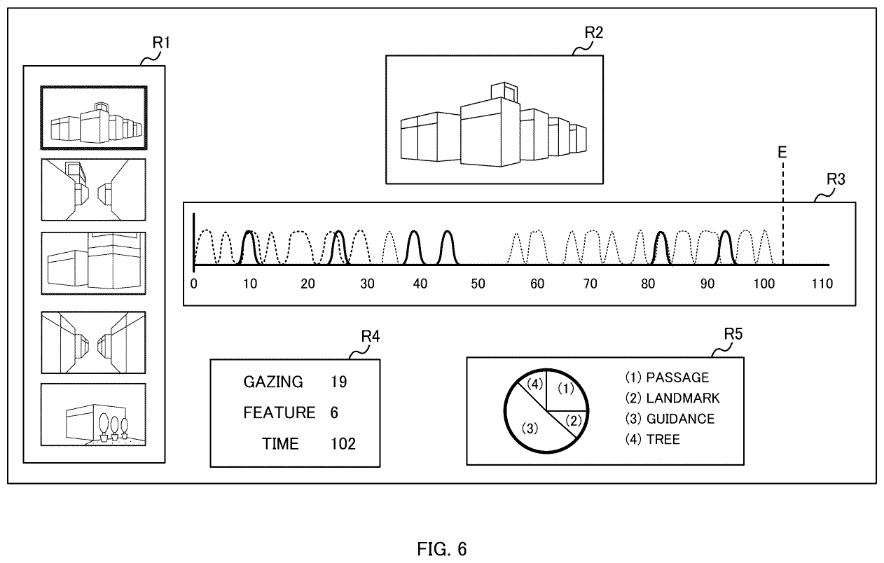

FIG. 6 shows an example of a screen including information outputted by the output part 234. FIG. 6 includes a region R1, a region R2, a region R3, a region R4, and a region R5. If the output part 234 displays a screen shown in FIG. 6 on the output terminal 3, the output part 234 can change information included in the screen in accordance with an operation of the designer or the like performed on the output terminal 3.

The region R1 is a region where a plurality of thumbnail images of a plurality of virtual space images are displayed, each corresponding to different elapsed times from when the user U starts viewing the virtual space image. The plurality of thumbnail images correspond to, for example, the virtual space image viewed by the user U at a time point when a multiple of a predetermined time (for example, 20 seconds) elapses from the time when viewing starts. The designer or the like using the output terminal 3 can change the displayed information to another region by selecting one thumbnail image from among the plurality of thumbnail images displayed in the region R1.

The region R2 is a region where the virtual space image corresponding to the thumbnail image selected by the designer or the like is displayed. In the region R2, the virtual space image corresponding to an elapsed time designated by the designer or the like may be displayed. Additionally, a plurality of thumbnail images may be displayed in a chronological order in the region R2. In this case, the output part 234 may display a thumbnail image having a feature designated by the designer or the like in a manner different from other thumbnail images. For example, the output part 234 causes the output terminal 3 to display a thumbnail image including the guidance information with a frame around them.

The output part 234 may display the thumbnail image of the virtual space image corresponding to the time point at which the feature manifestation time point and the gazing time point overlap, in the region R2. The output part 234 displays such a thumbnail image, making it easier for the designer or the like to grasp what type of specific feature is contained in the virtual space image that the user U gazes at.

The region R3 is a region where an image indicating the gazing time point and the feature manifestation time point within a predetermined time from the elapsed time corresponding to the thumbnail image selected by the designer or the like is displayed. The horizontal axis in the region R3 corresponds to the elapsed time from when the user U starts viewing the virtual space image corresponding to the selected thumbnail image. The vertical axis in the region R3 corresponds to the intensity of the gaze of the user U and the intensity of the specific feature shown by the virtual space image. A broken line E in the region R3 represents a point in time at which the user U ends viewing.

The slower the speed at which the user U changes the position of the virtual space image, the greater the intensity of the gaze. Further, the greater the degree to which the specific feature is shown in the virtual space image, the greater the intensity of the specific feature. For example, the longer a contour line indicating a single-point perspective composition, the greater the intensity of the feature of the single-point perspective composition. Similarly, the larger the size of the guidance information, the greater the intensity of the feature that the guidance information is contained.

Peaks indicated by dashed lines in the region R3 of FIG. 6 represent the gazing time points. The longer the duration of the peak, the longer the duration of the gaze. Peaks indicated by solid lines in the region R3 represent the feature manifestation time points. The manner in which the gazing time points and the feature manifestation time points are depicted is not limited to the manner shown in FIG. 6, and may be in any form.

As shown in the region R3, the output part 234 may output information indicating a viewing duration (for example, a broken line indicated by a reference sign E) in association with the gazing time point or the feature manifestation time point. The output part 234 outputs such information, making it easier for the designer or the like to easily grasp the correlation between a time during which the user U continues viewing, a trend of what the user U gazes at, and a trend of the feature of the virtual space image.

The output part 234 may be configured to change the type of feature for which the feature manifestation time point is outputted according to a setting made by the designer or the like. Specifically, if a “single-point perspective composition” is selected as the feature, the output part 234 causes the output terminal 3 to display the image shown in the region R3 in FIG. 6. If a “two-point perspective composition” is selected as the feature, the output part 234 displays an image indicating a point in time at which the two-point perspective composition is identified by the feature identification part 233 in the region R3.

The output part 234 may simultaneously display an image indicating a point in time at which each of the plurality of features is identified by the feature identification part 233 in a different manner in the region R3. That is, the output part 234 may display a plurality of types of feature manifestation time points corresponding to a plurality of different features, in the region R3 in a different manner for each type of feature. The output part 234 displays the points in time at which the plurality of different features are manifested on the same time axis as the gazing time point in this manner, making it easier for the designer or the like to easily grasp the features of the virtual space image that are likely to be gazed at by the user U.

The region R4 is a region where i) the number of times the user U gazes at the virtual space image within a predetermined period (for example, a time corresponding to the image shown in the region R3), ii) the number of times the specific feature is identified in the virtual space image, and iii) the time during which the user U continues viewing are displayed. In this manner, the output part 234 may further output information indicating the time during which the user U continues viewing the virtual space image in association with the number of times the user U gazes at the virtual space image or the number of times the specific feature is contained in the virtual space image.

The region R5 is a region where information indicating the proportion of time in which various objects are contained in the virtual space image viewed by the user U is displayed. As illustrated in FIG. 6, the output part 234 outputs information indicating the proportion of time in association with the virtual space image. In the region R5, the proportion of time each object is displayed within a time corresponding to the image shown in the region R3 is displayed, for example.

In the region R5, the proportion of time each object is displayed within a time range designated by the designer or the like may be displayed. In the region R5, i) the proportion of time each object is displayed within a predetermined time range immediately before a point in time at which the user U ends viewing the virtual space image and ii) the proportion of time each object is displayed within another time range may be simultaneously displayed. Displaying such information makes it easier for the designer or the like to easily grasp which virtual space images are more likely to cause the user U who is viewing to cease viewing.

The output part 234 may output state data indicating a result of estimating the biological state of the user U on the basis of the gazing time point and the feature manifestation time point. The biological state includes brain waves, heart rate, or perspiration level. For instance, the output part 234 outputs state data indicating an estimation result that the user U is in a specific biological state during a time period with a large number of gazing per unit time. The specific biological state is a state where θ waves are generated in the brain waves of the user U, for example. The state where the θ waves are generated refers to a state where brain waves with a frequency of 4 Hz or more and less than 8 Hz are generated. The θ waves are known to correlate with spatial cognition, and it is believed that the user U can more easily remember the image they are viewing when the θ waves are stronger.

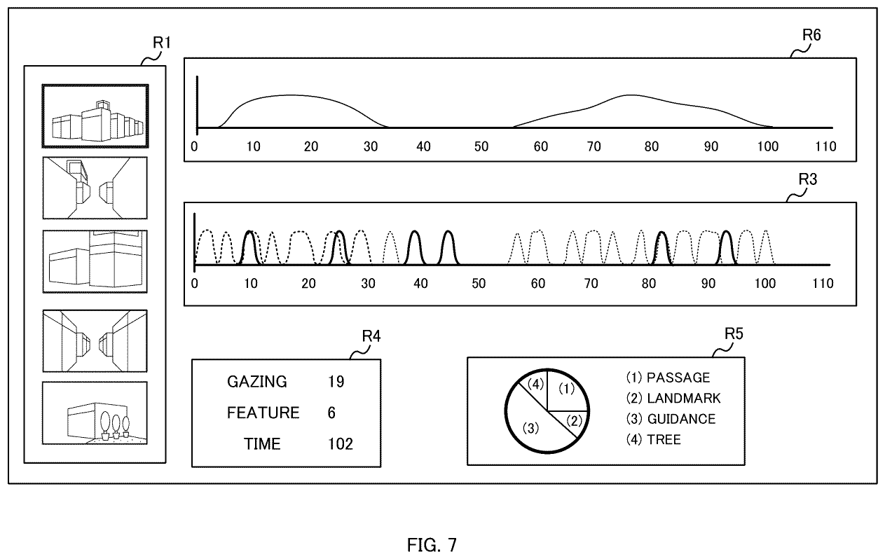

FIG. 7 shows an example of a screen on which an estimation result of the biological state is displayed. FIG. 7 includes the region R6 indicating the estimated biological state. In FIG. 7, it is shown that the level of the θ waves increases during a time period in which a) the gaze frequency is equal to or more than a threshold value and b) the gazing time point and the time point when the virtual space image includes a single-point perspective composition overlap with each other. The output part 234 outputs such state data, making it easier for the designer or the like to grasp the biological state of the user U while the user U is viewing the virtual space image, thereby improving the virtual space image in consideration of the biological state.

For example, the output part 234 may output the state data indicating the estimation result that the θ waves are generated in a time period in which i) the gazing time point and ii) a point in time at which the virtual space image includes a single-point perspective composition overlap with each other. In a case where the θ waves are generated in the user U, there is a high likelihood that if the virtual space image at a point in time of the θ wave generation includes an image of guidance information indicating a route, an image of a passage, an image of a landmark, or the like, the user U continues viewing the virtual space image for a longer time and more easily remember that virtual space image. Therefore, by knowing a state of the θ wave generation, the designer or the like can easily improve the virtual space image data in a way that facilitates the user U to continue viewing for a longer time and more easily remember the virtual space image.

In a case where the user U wears a device that measures their biological state and the data acquisition part 231 acquires data indicating the measured biological state via the information terminal 1, for example, the output part 234 may simultaneously display the estimated biological state and the measured biological state. The output part 234 operates in this manner, making it easier for the designer or the like to grasp the difference between the estimated biological state and the actual biological state. As a result, even if the user U does not wear the device for measuring their biological state, the designer or the like can easily grasp the actual biological state on the basis of the estimated biological state.

The output part 234 may i) input the data indicating the estimated biological state to a machine learning model that undergoes deep learning using both the data indicating the estimated biological state and the data indicating the measured biological state as teacher data and ii) output the data indicating the biological state after correction by the machine learning model.

It should be noted that, in FIG. 7, the region R6 is contained instead of the region R2 in FIG. 6, but the region R2 may be contained in FIG. 7. In this case, the virtual space image at the time when the user U is in the specific biological state may be displayed in the region R2. For example, the output part 234 causes the region R2 to display the virtual space image at the time when the level of the θ waves is high. The output part 234 outputs the virtual space image at the point in time at which the biological state is the predetermined state, making it easier for the designer or the like to easily grasp the relationship between the biological state and the virtual space image, thereby easily improving the virtual space image.

The output part 234 may output the estimation result of the biological state using a machine learning model that outputs the biological state by inputting the information indicating the gazing time point and the information indicating the feature manifestation time point. The machine learning model is generated through deep learning using teacher data consisting of a combination of i) a point in time at which a large number of users U, who view a virtual space image while their biological states are measured, gaze at the virtual space image, ii) a point in time at which the specific feature is contained in the virtual space image, and iii) a level of a biological state value (for example, θ waves) for each time. The output part 234 inputs, to the machine learning model, i) the information indicating the gazing time point displayed as in the region R3 and ii) the information indicating the feature manifestation time point, and outputs the estimation result of the biological state outputted from the machine learning model.

The relationship between the gazing time point and the feature manifestation time point is considered to vary depending on the attributes (for example, gender, age, and occupation) of the user U. Therefore, the output part 234 may output the gazing time point and the feature manifestation time point in association with the attribute of the user U stored in the storage 22. The output part 234 is configured in this manner, making it easier for the designer or the like to easily generate virtual space image data suitable for each of a plurality of attributes of the user U.

In order to enable the designer or the like to generate virtual space image data that is difficult for the user U to stop viewing midway through, it is desirable that the designer or the like can compare a) a gazing time point of a case where the user U stops viewing in a short time and b) a gazing time point of a case where the user U continues viewing for a long time. Accordingly, the output part 234 may display a plurality of images, each showing the gazing time point and the feature manifestation time point in a time sequence manner on the same time axis, the images corresponding to different durations during which the user U continues viewing the virtual space images.

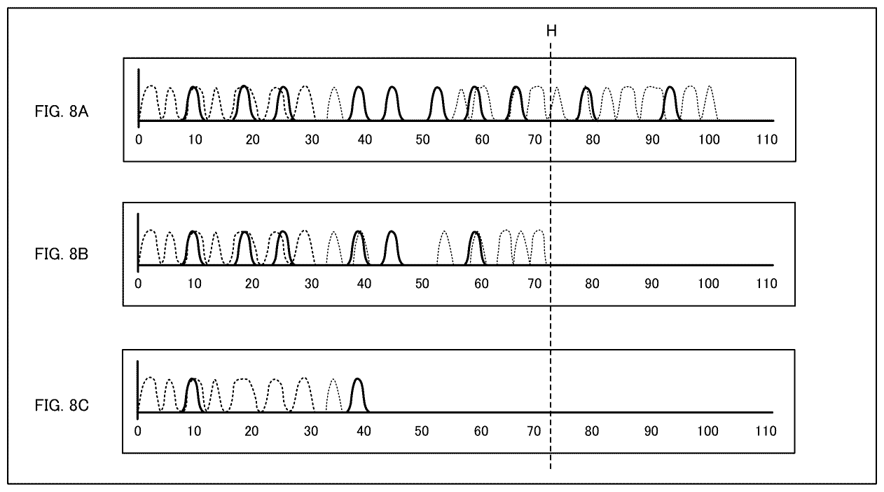

FIGS. 8A to 8C show an example of an image in which the gazing time point (broken line) and the feature manifestation time point (solid line) are shown in time series for different viewing durations. FIGS. 8A to 8C show the gazing time point and the like when users U having the same attribute view different virtual space images. A dashed line H in FIGS. 8A to 8C indicates an average viewing duration. The viewing time shown in FIG. 8A is the longest, as compared with FIGS. 8B and 8C. The viewing time shown in FIG. 8C is the shortest.

If the specific feature includes the single-point perspective composition, the designer or the like can grasp that it is desirable to include more single-point perspective compositions by comparing FIGS. 8A, 8B, and 8C. However, by only comparing these drawings, there is a possibility that the designer or the like overlooks a factor having a correlation with the viewing duration. Therefore, the output part 234 may output the result of identifying a pattern of manifestation of each of the plurality of features of the virtual space image in which the viewing duration is longer than the average viewing duration. As an example, the output part 234 outputs an interval between positions containing the specific features in the virtual space image data in which the viewing duration is longer than the average viewing duration, as a result of identifying the pattern of manifestation.

The output part 234 may output an improvement strategy for the virtual space image by using a machine learning model generated through deep learning, utilizing the pattern of manifestation of a plurality of features in a large number of virtual space images in which the viewing duration is longer than the average viewing duration, as teacher data. For example, when data indicating a point in time at which a specific feature is contained in the virtual space image, as shown in FIGS. 8B and 8C, is inputted, the machine learning model outputs data that indicates a point in time, closest to the inputted data, at which the specific feature is contained and the viewing duration is longer than the average viewing duration. The output part 234 outputs information indicating the difference between the data inputted to the machine learning model and the data outputted from the machine learning model, making it easier for the designer or the like to easily grasp how the virtual space image data may be modified to extend the viewing duration.

It should be noted that the output part 234 may output statistical information which is a result of a large number of users U viewing the virtual space image. As an example, the output part 234 may output i) an average value of the number of times of gazing when a plurality of users U view one virtual space image and ii) an average value of the viewing duration. Further, the output part 234 may output a correlation diagram in which the number of times of gazing and the viewing duration are plotted on the vertical axis and the horizontal axis. By grasping such statistical information, the designer or the like can easily improve the virtual space image data so that the viewing duration of the large number of users U becomes longer.

In addition, the output part 234 may display a movement path of the user U, a time spent at each point, the biological state of the user U, and a viewing angle of the user U (range of orientation changed at the same point) on a layout diagram corresponding to the virtual space image as shown in FIGS. 2A and 2B. Further, the output part 234 may output, on the basis of the movement of the user U, a result of classification of the user U's state into i) a selection stage where the user U does not know which direction to go, ii) a moving stage where the user U knows a direction to go, and iii) an arrival stage where the user U is gazing at an object.

### Second embodiment

### [Overview of Information Processing System S1]

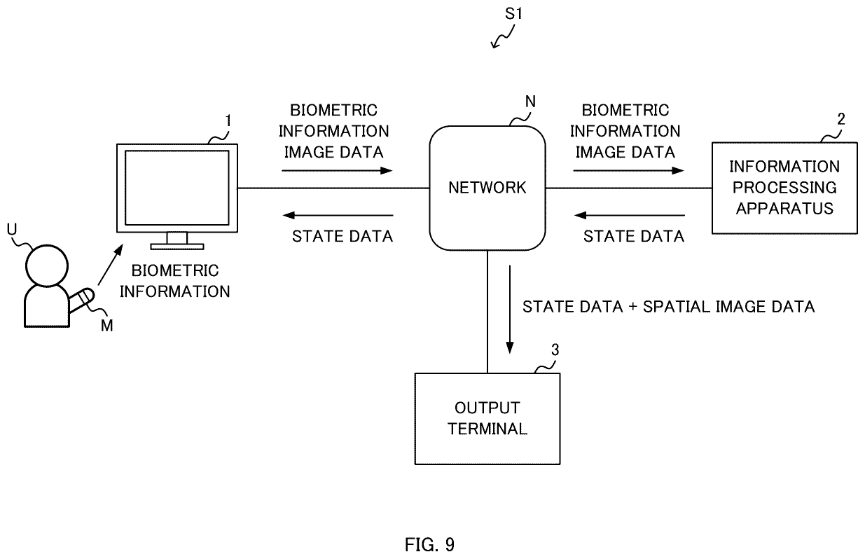

FIG. 9 shows an overview of an information processing system S1. The information processing system S1 is a system that displays data indicating a user U's state overlaid on a spatial image viewed by the user U. The spatial image may be an image of an actual space being viewed by the user U, or may be an image of the metaverse including a virtual reality image (VR image) generated by a computer.

Data indicating the user U's state is i) biometric information image data indicating a change in a value of biometric information of the user U over time or ii) state data identified on the basis of the biometric information image data, for example. The biometric information is, for example, information based on the heart rate, brain waves, perspiration, skin potentials, the line of sight of the user U, or a mouse or keyboard operation that sets a screen range indicating the line of sight of the user U, which is measured by a measuring device M, and is, for example, image information in the form of a graph. The user U's state may be what the user U is feeling or the physical or mental condition of the user U, while viewing the spatial image, which is determined on the basis of the biometric information of the user U. The user U's state is a relaxed state, a tense state, a concentration state, or an excited state, for example.

For example, an information terminal 1 displays the user U's state, identified by an information processing apparatus 2 on the basis of the biometric information image data, overlaid on the spatial image. Since the user U's state is overlaid on the spatial image viewed by the user U to be displayed, the user U viewing the spatial image can grasp their own state, and thus the user U can determine whether or not the spatial image that the user U is viewing is suitable for the user U. If the user U determines that the spatial image that they are viewing is not suitable for them, the user U can modify the spatial image to be a spatial image that is more suitable for them. Such an information processing system S1 is suitable for displaying an avatar image of the user U in the metaverse.

As shown in FIG. 9, the information processing system S1 includes the information terminal 1, the information processing apparatus 2, and an output terminal 3. The information terminal 1, the information processing apparatus 2, and the output terminal 3 are connected to the network N, and can transmit and receive data to and from other devices.

The information terminal 1 is a terminal used by the user U to view a spatial image, and is a personal computer, a tablet, a smartphone, or a spectacle-shaped or goggle-shaped terminal, for example. The information terminal 1 acquires the biometric information from the measuring device M worn by the user U, for example. The information terminal 1 displays the biometric information image data indicating changes in the value of the biometric information over time, together with the spatial image data. The biometric information image data is an augmented reality image (AR image), for example. The information terminal 1 transmits the biometric information image data and the spatial image data to the information processing apparatus 2.

The information processing apparatus 2 identifies the user U's state on the basis of the biometric information image data of the user U displayed on the information terminal 1. For example, when the biometric information image data is inputted, the information processing apparatus 2 identifies the user U's state by inputting the biometric information image data to a machine learning model that outputs data indicating the user U's state. The information processing apparatus 2 transmits state data indicating the identified state to the information terminal 1. The information terminal 1 that receives the state data displays the state data together with the spatial image data.

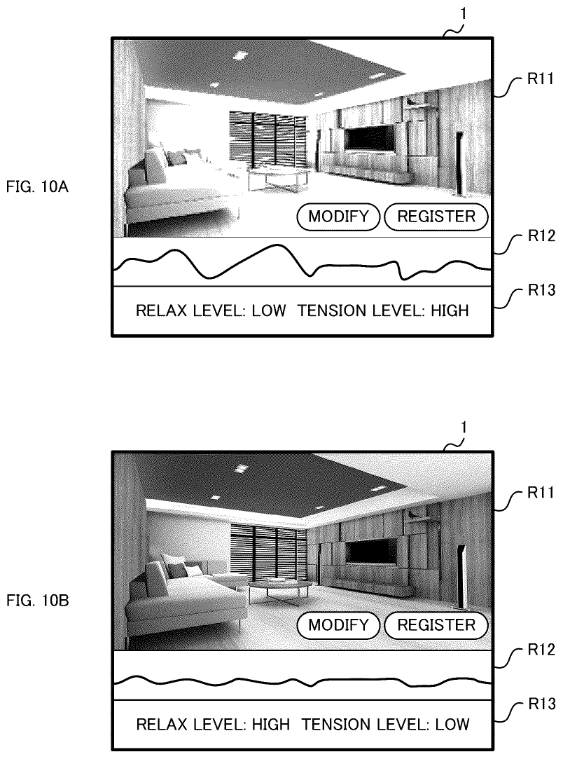

FIGS. 10A and 10B show an example of a screen displayed on the information terminal 1. The spatial image data is displayed in a region R11, the biometric information image data is displayed in a region R12, and the state data transmitted from the information processing apparatus 2 is displayed in a region R13. The user U can grasp their own state by viewing the biometric information image data displayed in the region R12, but can objectively grasp their own state by viewing the state data displayed in the region R13.

A “modify” icon for receiving an operation from the user U for modifying the aspect of the spatial image is displayed in the region R11. When the user U selects the “modify” icon, the aspect of the spatial image displayed in the region R1 is modified. The aspect of the spatial image includes hue, saturation, brightness, texture, shape, or arrangement of elements such as floors, walls, ceilings, or furniture, for example. The information terminal 1 may display a plurality of candidates for the spatial image after modification or may also display a recommended spatial image in response to the selection of the “modify” icon. In addition, a method of selecting the icon may be clicking, tapping, or other methods such as gazing, blinking, or winking via eye-tracking, or gestures via hand-tracking.

Further, in the region R11, a “register” icon is displayed for registering the displayed spatial image as the user U's favorite image. When the “register” icon is selected, the information terminal 1 stores the displayed spatial image as the user U's favorite image or transmits the spatial image to the information processing apparatus 2.

In the example shown in in FIG. 10A, the spatial image displayed in the region R11 has high brightness, and the region R13 shows a state where the relaxation level is low and the tension level is high. If the spatial image displayed in region R11 is an image of a living room and the user U feels that they want to relax in the living room, the user U selects the “modify” icon and the information terminal 1 modifies the spatial image in a manner that may cause a change in the user U's state displayed in the region R13.

FIG. 10B shows a screen that displays a spatial image having a brightness lower than that of the spatial image shown in FIG. 10A. In this state, it is shown that the fluctuation of the biometric information displayed in the region R12 is small, and the relaxation level is high in the region R13. The user U can register the spatial image displayed in FIG. 10B by selecting the “register” icon. It should be noted that the aspect of the spatial image may be indicated by hue and saturation instead of or in addition to brightness.

The information terminal 1 may transmit the displayed spatial image data to the information processing apparatus 2. Then, the information processing apparatus 2 may output the state data and the spatial image data in association with each other to a device other than the information terminal 1. For example, the information processing apparatus 2 may transmit the state data and the spatial image data in association with each other to the output terminal 3, which is different from the information terminal 1, or may print the state data and the spatial image data in association with each other. The output terminal 3 is a computer used by a person who designs buildings or spaces, or the image data thereof, such as a designer, a researcher, or a marketer (hereinafter referred to as a “designer or the like”). The output terminal 3 displays the state data and the spatial image data in association with each other, and so a designer or the like can grasp what kind of impression the user U has of various spaces, which can then be used for their design process.

### [Configuration of Information Terminal 1]

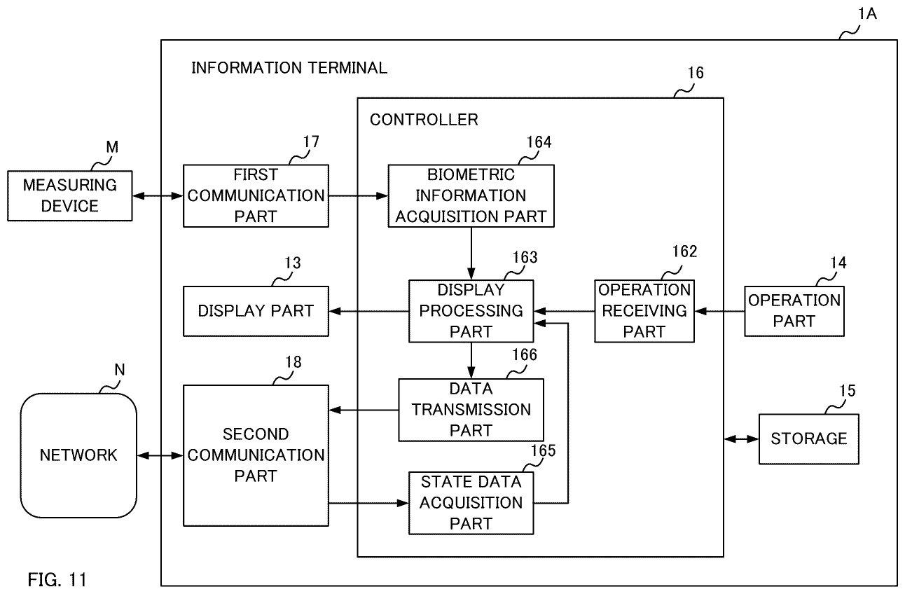

FIG. 11 shows a configuration of the information terminal 1. The information terminal 1 includes a display part 13, an operation part 14, a storage 15, a controller 16, a first communication part 17, and a second communication part 18. The controller 16 includes an operation receiving part 162, a display processing part 163, a biometric information acquisition part 164, a state data acquisition part 165, and a data transmission part 166.

The first communication part 17 has a communication interface for transmitting and receiving data to and from the measuring device M. The first communication part 17 includes a wireless communication interface such as Bluetooth (registered trademark) or Wi-Fi (registered trademark). The first communication part 17 inputs the biometric information received from the measuring device M to the biometric information acquisition part 164.

The second communication part 18 has a communication interface for transmitting and receiving data to and from the information processing apparatus 2 via the network N. For example, the second communication part 18 transmits the biometric information image data and the spatial image data inputted from the data transmission part 166 to the information processing apparatus 2, and ii) inputs the state data received from the information processing apparatus 2 to the state data acquisition part 165.

The display part 13 is a display that displays various kinds of information. The display part 13 displays a spatial image based on the spatial image data, for example. Further, the display part 13 i) generates biometric information image data based on the biometric information of the user U who is viewing the spatial image and ii) displays biometric information image based on the generated biometric information image data. Furthermore, when the second communication part 18 receives the state data from the information processing apparatus 2, the display part 13 displays text based on the state data.

The operation part 14 is a device that receives an operation of the user U, and includes a keyboard and a mouse, for example. The operation part 14 inputs data indicating the operation content of the user U to the operation receiving part 162.

The storage 15 includes a storage medium such as a ROM, a RAM, and an SSD. The storage 15 stores a program executed by the controller 16. Further, the storage 15 temporarily stores spatial image data, biometric information, biometric information image data, and the like. In association with the timing at which the biometric information is acquired, the storage 15 stores i) the biometric information image data and ii) the spatial image data displayed on the display part 13 at that timing, for example.

Moreover, the storage 15 stores recommended state data used by the display processing part 163 to modify the aspect of the spatial image displayed on the display part 13. The recommended state data is data in which i) information for identifying the spatial image (for example, a spatial image name) and ii) a state recommended as a user's state when viewing the spatial image are associated with each other.

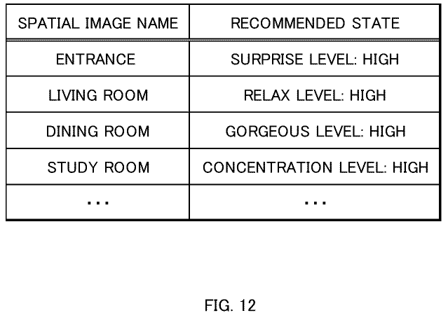

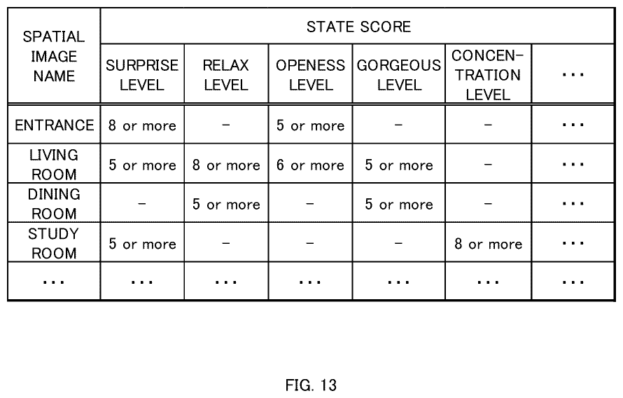

FIGS. 12 and 13 show examples of recommended state data. In the example shown in FIG. 12, a recommended state of “surprise level: high” is associated with a spatial image of an entrance. Further, a recommended state of “relaxation level: high” is associated with a spatial image of a living room. In the recommended state data, a plurality of recommended states may be associated with a single spatial image name.

The recommended state data may be described in a program of application software executed by the controller 16, but the desired state in each space may vary depending on the user U. Therefore, the storage 15 may store the recommended state for each spatial image set by the user U via the operation part 14. In addition, the recommended state data may include data indicating a non-recommended state rather than the recommended state.

As shown in FIG. 13, the recommended state data may include a numerical value indicating an acceptable range of scores for the state of the user U who views the spatial image, in association with the spatial image name. In the example shown in FIG. 13, a score required for the “surprise level” at the entrance is “8 or more,” and a score required for the “openness level” is “5 or more,” while scores required for other states are arbitrary. As described above, since the recommended state data includes data indicating the acceptable range for each type of state, it becomes easier to reflect the preferences of the user U for each space.

Further, the storage 15 may store data indicating a trend of the relationship between the aspect of the spatial image and the user U's state. As an example, the storage 15 stores data indicating trends such as i) when the user U views a spatial image with low brightness, the user U tends to feel calmer compared to viewing a spatial image with high brightness, or ii) when the user U views a spatial image with a single-point perspective, the user U tends to feel calmer compared to viewing a spatial image with a two-point perspective. This data is used when the aspect of the spatial image displayed by the display processing part 163 is modified.

The controller 16 includes a CPU. The controller 16 functions as the operation receiving part 162, the biometric information acquisition part 164, the state data acquisition part 165, the display processing part 163, and the data transmission part 166 by executing the program stored in the storage 15.

The operation receiving part 162 receives an operation of the user U on the basis of data inputted from the operation part 14. The operation receiving part 162 notifies an appropriate processing unit in the controller 16 of the content of the received operation. For example, the operation receiving part 162 notifies the display processing part 163 that the operation of the user U selecting the “modify” icon, shown in FIGS. 10A and 10B, has been received. In addition, the operation receiving part 162 notifies the display processing part 163 that an operation of selecting one candidate from among a plurality of candidates of the spatial image after modification displayed on the display part 13 has been received. A method of selecting the icon may be clicking, tapping, or other methods such as gazing, blinking, or winking via eye-tracking, or gestures via hand-tracking.

The biometric information acquisition part 164 acquires, via the first communication part 17, biometric information of a user who is viewing the spatial image in the information terminal 1. The biometric information acquisition part 164 inputs the acquired biometric information to the display processing part 163.

The state data acquisition part 165 acquires the state data outputted by the information processing apparatus 2 via the second communication part 18. The state data acquisition part 165 inputs the acquired state data to the display processing part 163.

The display processing part 163 causes the display part 13 to display various kinds of information by generating screen data to be displayed on the display part 13. The display processing part 163 displays, for example, a virtual image based on the virtual image data stored in the storage 15 on the display part 13. In addition, as shown in FIGS. 10A and 10B, the display processing part 163 displays the biometric information image based on the biometric information overlaid on the spatial image. Further, when the state data acquisition part 165 acquires the state data via the second communication part 18, the display processing part 163 displays text or an image based on the acquired state data on the display part 13 overlaid on the spatial image. The display processing part 163 may display the biometric information image of the user U in real-time, or may display an image showing the biometric information for a predetermined period of time in the past (for example, several seconds set by the user U).

If the state data acquired by the state data acquisition part 165 indicates a predetermined state corresponding to a case of modifying the spatial image data, the display processing part 163 displays updated spatial image data corresponding to an updated spatial image different from the spatial image being displayed. The predetermined state is, for example, a state different from the recommended state indicated by the recommended state data stored in the storage 15 in association with the spatial image name.

The display processing part 163 modifies the aspect of the spatial image or updates the spatial image to another spatial image so as to bring the state indicated by the state data closer to the state indicated by the recommended state data. For example, the display processing part 163 modifies the brightness or the composition of the spatial image by referring to the data indicating the trend of the relationship between the aspect of the spatial image and the user U's state stored in the storage 15. The display processing part 163 may continue to modify the aspect of the spatial image until the state indicated by the state data falls within the acceptable range indicated by the recommended state data.

The display processing part 163 may display one or more updated spatial image candidates, which may bring the state indicated by the state data closer to the state indicated by the recommended state data, on the display part 13 after displaying the state data acquired by the state data acquisition part 165. The display processing part 163 determines the updated spatial image candidate by referring to the data indicating the trend of the relationship between the aspect of the spatial image and the user U's state stored in the storage 15. As an example, when it is necessary to increase a calmness level, the display processing part 163 determines a spatial image having a brightness lower than that of the displayed spatial image as the updated spatial image candidate.

The display processing part 163 may display an updated spatial image corresponding to the selected updated spatial image candidate in response to the operation receiving part 162 receiving an operation of selecting one updated spatial image candidate from among the one or more updated spatial image candidates, after displaying the one or more updated spatial image candidates. The display processing part 163 operates in this manner, and so i) the user U's state becomes the recommended state and ii) a spatial image with an aspect preferred by the user U can be displayed on the display part 13.

The display processing part 163 may display the avatar image of the user U overlaid on the spatial image, which is the metaverse image. The display processing part 163 displays an avatar image wearing clothing in a color selected by the user U, for example, and the biometric information image or the state data together with the spatial image. The display processing part 163 displays the avatar image of the user U and the biometric information image or the state data, therefore it is possible to adjust the avatar image or the metaverse image so that the user U's state becomes an appropriate state when the avatar selected by the user U is displayed in the metaverse.

The data transmission part 166 transmits the biometric information image data corresponding to the biometric information image to the information processing apparatus 2. For example, the data transmission part 166 cuts out the biometric information image data displayed in the region R2 of FIGS. 10A and 10B from the screen displayed on the display part 13, and transmits the cut-out biometric information image data to the information processing apparatus 2. Since the size of the biometric information image data is smaller than that of the virtual space image data, the data transmission part 166 operates in this manner to reduce the amount of data transmitted to the information processing apparatus 2.

The data transmission part 166 may transmit, to the information processing apparatus 2, i) the biometric information image data and ii) the spatial image data corresponding to the spatial image with the biometric information image corresponding to the biometric information image data displayed. The data transmission part 166 may normally transmit only the biometric information image data to the information processing apparatus 2, and if receiving a request for the spatial image data from the information processing apparatus 2, the data transmission part 165 may i) read the spatial image data displayed on the display part 13 at the time when the measuring device M acquires the biometric information corresponding to the biometric information image data from the storage 15 and ii) transmit the read spatial image data to the information processing apparatus 2.

In addition, if the avatar image is displayed to be overlaid on the spatial image, the data transmission part 166 may transmit the spatial image data in a state where the avatar image is deleted to the information processing apparatus 2. The data transmission part 166 transmits the spatial image data without the avatar image to the information processing apparatus 2, and so a designer or the like who views the spatial image data outputted from the information processing apparatus 2 can evaluate or analyze the spatial image data without being affected by the avatar image.

### [Configuration of Information Processing Apparatus 2]

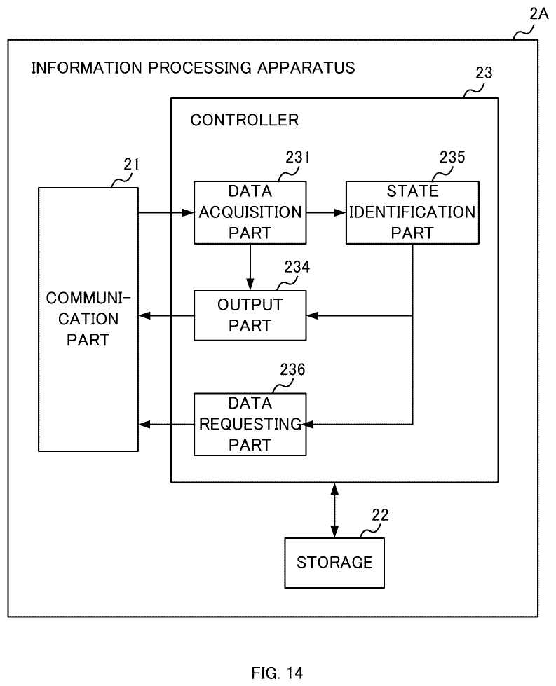

FIG. 14 shows a configuration of the information processing apparatus 2A. The information processing apparatus 2 includes a communication part 21, a storage 22, and a controller 23. The controller 23 includes a data acquisition part 231, a state identification part 235, an output part 234, and a data requesting part 236.

The communication part 21 includes a communication interface for transmitting and receiving data to and from the information terminal 1 and the output terminal 3 via the network N. The communication part 21 inputs the received data to the data acquisition part 231. Further, the communication part 21 transmits the data inputted from the output part 234 and the data requesting part 236.

The storage 22 includes a storage medium such as a ROM, a RAM, and an SSD. The storage 22 stores a program executed by the controller 23. The storage 22 stores data that is used for identifying the user U's state on the basis of the biometric information image data. Said data is data in which i) the feature of the waveform of the biometric information indicated by the biometric information image data and ii) the user U's state are associated with each other, for example. Said data may be a machine learning model that outputs data indicating the user U's state when the biometric information image data is inputted.

Further, the storage 22 may store attributes of the user U in association with the user identification information for identifying the user U. The attributes of the user U include age, gender, family composition, or residential region, for example.

The controller 23 includes a CPU, and functions as the data acquisition part 231, the state identification part 235, the output part 234, and the data requesting part 236 by executing the program stored in the storage 22.

The data acquisition part 231 acquires biometric information image data from the information terminal 1 via the communication part 21. For example, the data acquisition part 231 acquires the biometric information image data in association with the user identification information of the user U. The data acquisition part 231 inputs the acquired biometric information image data to the state identification part 235 and the output part 234.

The data acquisition part 231 may acquire, via the communication part 21, the spatial image data displayed on the information terminal 1. The data acquisition part 231 may i) acquire the biometric information image data and the spatial image data in association with each other or ii) acquire, after acquiring the biometric information image data, the spatial image data displayed on the information terminal 1 at the time when the biometric information corresponding to that biometric information image data is acquired by the measuring device M.

The state identification part 235 identifies the user U's state on the basis of the biometric information image data. The state identification part 235 identifies, as the user U's state, a state associated with the feature of the waveform of the biometric information indicated by the biometric information image data in the storage 22. The state identification part 235 may input the biometric information image data into a machine learning model that has been learned in advance using a large number of sets of the biometric information image data and the user U's state as teacher data, and identify the user U's state on the basis of the data indicating the state outputted from the machine learning model. The state identification part 235 notifies the output part 234 of the identified user's state.

The output part 234 outputs the state data indicating the user U's state identified by the state identification part 235. The output part 234 transmits the state data of the user U to the information terminal 1 used by the user U via the communication part 21, for example. The output part 234 may transmit the state data of the user U to the output terminal 3 via the communication part 21.

The output part 234 may output, in association with the spatial image data, the state data indicating the user's state identified on the basis of the biometric information image data corresponding to the biometric information acquired at the time when the spatial image data is displayed. That is, the output part 234 may transmit i) the state data and ii) the spatial image data displayed on the information terminal 1 at the time when the biometric information corresponding to the biometric information image data used for identifying the state data is acquired by the measuring device M, in association with each other. The output part 234 outputs the state data and the spatial image data in association with each other, and so a designer or the like who confirms these pieces of data can easily grasp the user U's state in each space.

There are cases where the way the user U perceives a space differs depending on the attributes of user U. Therefore, the output part 234 may identify an attribute corresponding to the user identification information associated with the biometric information image data acquired by the data acquisition part 231 by referring to the storage 22, and may output i) the spatial image data corresponding to the spatial image displayed at the time when the biometric information corresponding to that biometric information image data is acquired, ii) the state data, and iii) the identified attribute in association with each other. The output part 234 outputs the spatial image data and the state data in association with the attributes of the user U, allowing a designer or the like who confirms these pieces of data to more easily grasp how the user U's perception of each space differs depending on their attributes.

However, there is a need for a designer or the like to grasp what kind of space makes the user U more likely to achieve a predetermined state. Therefore, the output part 234 may output one or more pieces of spatial image data, which are transmitted in association with one or more pieces of biometric information image data corresponding to respective types of the user U's state, associated with the types of states indicated by the state data. As an example, when a designer or the like performs an operation for grasping an example of a space where people can relax, the output part 234 i) selects one or more pieces of spatial image data associated with the biometric information image data identified to be corresponding to the relaxed state by the state identification part 235 and ii) outputs the selected spatial image data as a space where people can be relaxed.

In order to suppress the variation due to the individuality of the user U, the output part 234 may select a plurality of pieces of spatial image data associated with a plurality of pieces of biometric information image data identified to be corresponding to the relaxed state of the user U, among various states of the user U identified by the state identification part 235 using the biometric information image data acquired by the data acquisition part 231 from a plurality of information terminals 1. A designer or the like can easily grasp what kind of space is a space where a large number of users U can be relaxed by viewing such a plurality of pieces of spatial image data.

Since there is a possibility that the trend varies depending on the user U's attribute, the output part 234 may output a plurality of pieces of spatial image data in association with the user U's attribute and the type of the user U's state. In this case, the output part 234 classifies the plurality of pieces of biometric information image data corresponding to the state, set by a designer or the like, for each attribute of the user U of the information terminal 1 that has transmitted the biometric information image data. The output part 234 then selects a plurality of pieces of spatial image data corresponding to the plurality of pieces of biometric information image data for each of the classified attributes.

When the output part 234 outputs the spatial image data corresponding to the predetermined state, if the data acquisition part 231 continues to acquire the spatial image data together with the biometric information image data, the amount of data transmitted over the network N increases, and the processing load of the data acquisition part 231 also increases. Therefore, when the state identification part 235 identifies that the user U's state becomes the predetermined state, the data requesting part 236 transmits, to the information terminal 1, request data for requesting the spatial image data corresponding to the spatial image displayed at the time when the biometric information corresponding to the biometric information image data, in which the predetermined state was identified, is acquired.

The predetermined state is i) a state set by a designer or the like or ii) a state after a change occurs in the user U's state, for example. The request data includes an ID or a time stamp as information for identifying the biometric information image data, for example.

In response to receiving the request data, the information terminal 1 reads, from the storage 15, the spatial image data displayed at the timing when the biometric information corresponding to the biometric information image data indicated by the request data is acquired, and the data transmission part 166 transmits the read spatial image data. The output part 234 outputs the spatial image data transmitted by the information terminal 1 in response to the data requesting part 236 transmitting the request data to the information terminal 1, in association with the state data indicating the predetermined state. The information terminal 1 and the information processing apparatus 2 are configured in this manner, and so the amount of spatial image data transmitted and received between the information terminal 1 and the information processing apparatus 2 can be reduced, thereby reducing the load on the network N, the information terminal 1, and the information processing apparatus 2.

### [Processing in Information Processing System S1]

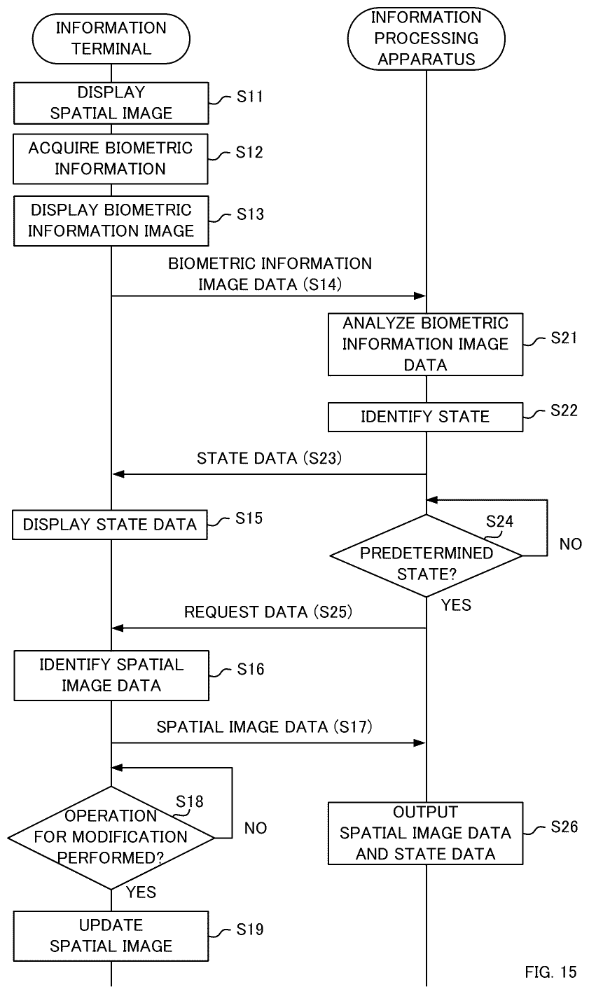

FIG. 15 is a sequence diagram showing an example of processing in the information processing system S1. In the sequence diagram shown in FIG. 15, a case where the state data is displayed on the information terminal 1 is exemplified. The sequence diagram shown in FIG. 15 starts from a state in which the user U views the spatial image.

In the information terminal 1, while the display processing part 163 displays the spatial image based on the spatial image data on the display part 13 (S11), the biometric information acquisition part 164 acquires the biometric information of the user U from the measuring device M (S12). The display processing part 163 generates biometric information image data based on the biometric information, and displays the biometric information image on the display part 13 (S13). The data transmission part 166 transmits the biometric information image data to the information processing apparatus 2 (S14).

In the information processing apparatus 2, the state identification part 235 analyzes the biometric information image data received from the information terminal 1 (S21), and identifies the user U's state (S22). The output part 234 outputs the identified state data (S23). In the example shown in FIG. 15, the output part 234 transmits the state data to the information terminal 1, but the output part 234 may transmit the state data to the output terminal 3. When the state data acquisition part 165 acquires the state data, the display processing part 163 displays the state data on the display part 13 (S15).

While the processing from S11 to S15 is performed, the data requesting part 236 monitors whether the state identified by the state identification part 235 is the predetermined state (S24). If it is determined that the state identified by the state identification part 235 is the predetermined state (YES in S24), the data requesting part 236 transmits the request data for requesting the spatial image data to the information terminal 1 (S25).

The data transmission part 166 identifies the spatial image data displayed on the display part 13 at the timing identified on the basis of the request data by referring to the spatial image data stored in the storage 15 (S16), and transmits the identified spatial image data to the information processing apparatus 2 (S17). The output part 234 outputs the spatial image data and the state data in association with each other (S26).

While the spatial image data is displayed on the display part 13, the operation receiving part 162 monitors that an operation for modifying the spatial image has been performed, in the information terminal 1 (S18). If the operation receiving part 162 detects that the operation for modifying the aspect of the spatial image has been performed (YES in S18), the display processing part 163 updates the spatial image data so that the user U's state is improved on the basis of the spatial image data displayed at that time and the state indicated by the state data (S19).

### [Effect of Information Processing System S1]

In the conventional system, a person (for example, a designer, a researcher, or a marketer) other than a user viewing a virtual space, such as a space in which a virtual reality space or an augmented reality image is displayed, can know a reaction of the user. However, there is a problem in that the user (for example, a user who is only viewing the virtual space, and a designer, a researcher, or a marketer involved in generating the virtual space) cannot objectively grasp their own state while viewing the space.

In contrast, the information terminal 1 in the information processing system S1 transmits the biometric information image data indicating the waveform of the biometric information acquired while the user U is viewing the spatial image to the information processing apparatus 2, and the information processing apparatus 2 identifies the user U's state on the basis of the biometric information image data and generates the state data. The information terminal 1 displays the state data received from the information processing apparatus 2 together with the spatial image, so that the user U can objectively grasp their own state while viewing the spatial image. As a result, the user U can switch to a spatial image suitable for them. Such an information processing system S1 is suitable for displaying one's own avatar in the metaverse.

Further, in the information processing system S1, the information processing apparatus 2 analyzes the biometric information image data displayed on the information terminal 1 to identify the user U's state. Therefore, the information processing apparatus 2 can identify the user U's state even if the biometric information cannot be directly acquired from the measuring device M.

Then, the information processing apparatus 2 acquires the spatial image data from the information terminal 1 and outputs the acquired spatial image data and the state data in association with each other. Since the information processing apparatus 2 outputs such data, a designer or the like can easily grasp what kind of spatial image is desirable to be used. In addition, the information processing apparatus 2 acquires the spatial image data when the predetermined state is detected, allowing the amount of received data to be reduced as compared with a case where the spatial image data is always transmitted from the information terminal 1 to the information processing apparatus 2, thereby reducing the processing load of the information processing apparatus 2.

The technique according to the present embodiment is suitable for a case where a user who views a real space or a virtual space (including a metaverse space) is positively and actively interested in a space experienced by the user without depending on a designer of the space, and allowing the user himself/herself to contribute to improving the space.

### [Overview of Information Processing System S2]

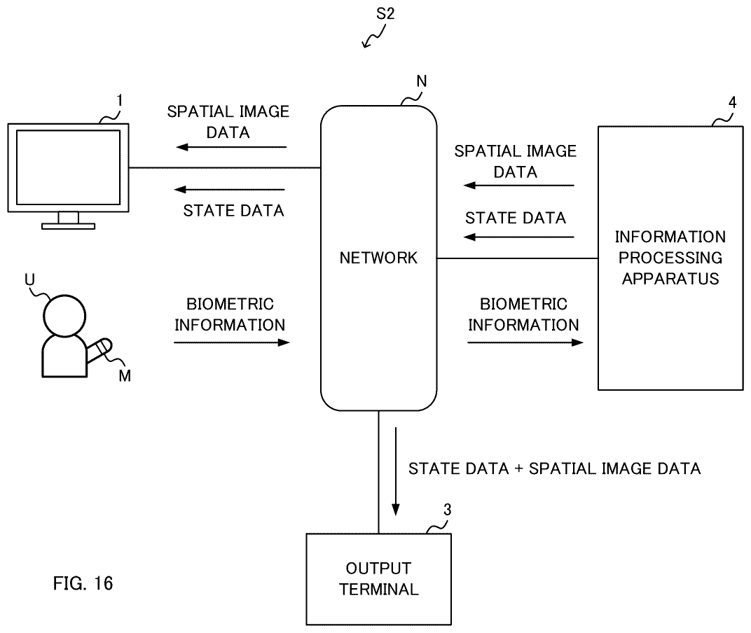

FIG. 16 shows an overview of the information processing system S2. The information processing system S2 includes an information processing apparatus 4 instead of the information processing apparatus 2 in the information processing system S1, and the information processing apparatus 4 transmits spatial image data to the information terminal 1. While the user U is viewing the spatial image, the measuring device M transmits the biometric information to the information processing apparatus 4 via the network N. The information processing apparatus 4 identifies the user U's state on the basis of the received biometric information, and transmits the state data to the information terminal 1. The information processing apparatus 4 may transmit the biometric information image data to the information terminal 1. With such a configuration, the information terminal 1 can display the user U's state while displaying the spatial image as shown in FIGS. 10A and 10B.

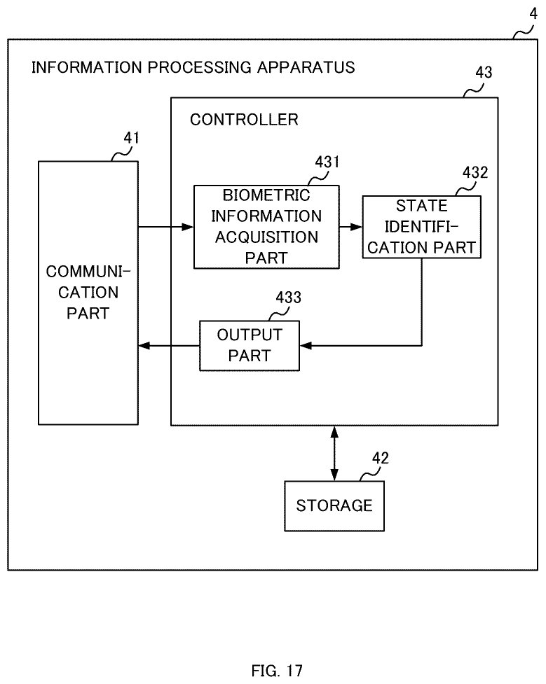

FIG. 17 shows a configuration of the information processing apparatus 4. The information processing apparatus 4 includes a communication part 41, a storage 42, and a controller 43.

The communication part 41 corresponds to the communication part 21 in the information processing apparatus 2 shown in FIG. 14, and the storage 42 corresponds to the storage 22 in the information processing apparatus 2. The storage 42 stores spatial image data to be displayed on the information terminal 1. When the output part 433 described later transmits the spatial image data, the storage 42 stores information (for example, identification information of the information terminal 1 or identification information of the user U) indicating a transmission destination of the spatial image data and a transmission time in association with the spatial image data.

The storage 42 may store the recommended state data stored in the storage 15 of the information terminal 1 in the information processing system S1 and the data indicating the trend of the relationship between the aspect of the spatial image and the user U's state.

The controller 43 includes a CPU corresponding to the controller 23 in the information processing apparatus 2, and functions as a biometric information acquisition part 431, a state identification part 432, and an output part 433 by executing a program stored in the storage 42.

The biometric information acquisition part 431 acquires the biometric information transmitted by the measuring device M via the communication part 41. That is, the biometric information acquisition part 431 acquires the biometric information of the user U who is viewing the spatial image data displayed on the information terminal 1. The biometric information acquisition part 431 inputs the acquired biometric information to the state identification part 432.

The state identification part 432 has a function equivalent to the function of the state identification part 235 in the information processing apparatus 2, and identifies the user U's state on the basis of the biometric information inputted from the biometric information acquisition part 431. The state identification part 432 inputs state data indicating the identified state to the output part 433.

The output part 433 has a function equivalent to the function of the display processing part 163 in the information processing system S1. Specifically, the output part 433 displays the spatial image on the information terminal 1 by transmitting the spatial image data. In addition, the output part 433 outputs i) the state data indicating the user U's state identified by the state identification part 432 and ii) the spatial image data displayed on the information terminal 1 at the time when the biometric information corresponding to the state data is acquired, in association with each other. For example, the output part 433 can display the user U's state on the information terminal 1 while the user U is viewing the spatial image by transmitting the state data inputted from the state identification part 432 to the information terminal 1.

The output part 433 may modify the spatial image data to be displayed on the information terminal 1 on the basis of the user U's state identified by the state identification part 432. Specifically, similarly to the display processing part 163 in the information processing system S1, the aspect of the spatial image data may be modified so as to bring the user U's state closer to the recommended state by using the recommended state data stored in the storage 42 and the data indicating the trend of the relationship between the aspect of the spatial image and the user U's state.

The output part 433 may output the spatial image data and the state data to the output terminal 3 in association with each other. In this case, the output part 433 identifies the spatial image data stored in the storage 42 in association with the timing at which the biometric information acquisition part 431 acquires the biometric information, and transmits the identified spatial image data and the state data in association with each other to the output terminal 3. Similarly to the information processing system S1, the output part 433 may further output the spatial image data and the state data in association with the attribute of the user U.

It should be noted that the information processing apparatus 4 may cause the information terminal 1 connected to the information processing apparatus 4 to display i) the spatial image data and ii) at least one of the biometric information image data or the state data, without using the network N. Further, the information processing apparatus 4 may be a computer used by the user U, and the information processing apparatus 4 may cause the display to display i) the spatial image data and ii) at least one of the biometric information image data or the state data.

In addition, the information processing apparatus 4 may i) acquire the biometric information of a plurality of users U from the information terminals 1 used by the plurality of users U, and ii) transmit the plurality of pieces of biometric information image data indicating the biometric information of the plurality of users U viewing the same spatial image to the plurality of information terminals 1 used by the plurality of users U viewing the same spatial image. In this case, each of the information terminals 1 displays the plurality of pieces of biometric information image data corresponding to the plurality of users U transmitted from the information processing apparatus 4 overlaid on the spatial image data. When the information terminal 1 displays such a screen, the user U can compare their own state with the state of another person.

The information processing apparatus 4 may transmit the plurality of pieces of biometric information image data corresponding to the plurality of users U to the output terminal 3. In this case, the output terminal 3 displays the plurality of pieces of biometric information image data overlaid on the spatial image data. The output terminal 3 displays such a screen, and so a designer or the like can easily grasp states of the plurality of users U who view the spatial image, and thus can design the spatial image in consideration of many users U.

### [Effects of Information Processing System S2]

Also in the information processing system S2, the user U's state while the user U is viewing the spatial image is displayed on the information terminal 1 as in the information processing system S1, and so the user U can objectively grasp their own state while viewing the spatial image. In the information processing system S2, the information processing apparatus 4 provides the spatial image data to the information terminal 1 and provides the state data identified on the basis of the acquired biometric information to the information terminal 1, the same effect as that of the information processing system S1 can be obtained even in a general-purpose computer in which the information terminal 1 does not have a function of acquiring the biometric information or storing the spatial image data in advance.

### [Modification]

In the above description, image data in the form of a graph based on the heart rate or brain waves is mainly exemplified as the biometric information image data, but the biometric information image data may be image data indicating the gaze position of the user U. For example, the image data indicating the gaze position of the user U is data of a heat map image in which colors or patterns vary depending on regions in the spatial image that the user U views for a longer or shorter period of time. In this case, the measuring device M is a spectacle-type or goggle-type terminal, for example, and the direction of the line of sight of the user U is identified by a sensor included in the terminal, so that the region viewed by the user U is identified. The user U can grasp which region of the spatial image they tend to focus on by viewing the heat map image.

The information processing apparatus 2 or the information processing apparatus 4 may output the spatial image data with the heat map image data overlaid to the output terminal 3. This allows a designer or the like to design the spatial image in consideration of the region that the user U is likely to focus on. In addition, the information processing apparatus 2 or the information processing apparatus 4 may analyze the heat map image data to analyze a region where the user U tends to focus on, or analyze the emotion of the user U on the basis of the tendency of the movement of the line of sight of the user U, and output the analysis result. Accordingly, a designer or the like can easily design the spatial image in consideration of emotions.

The present disclosure is explained on the basis of the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Further, new exemplary embodiments generated by arbitrary combinations of them are included in the exemplary embodiments of the present disclosure. Further, effects of the new exemplary embodiments brought by the combinations also have the effects of the original exemplary embodiments.

What is claimed is:

1. An information processing system comprising:
an information terminal; and
an information processing apparatus that is capable of communicating with the information terminal, wherein
the information terminal includes:
an operation receiving part that receives an operation of a user, and
a display processing part that displays a virtual space image by changing a displayed region and a displaying orientation of virtual space image data provided from the information processing apparatus, on the basis of an operation of the user received by the operation receiving part, and
the information processing apparatus includes:
a data acquisition part that acquires display state data for identifying the virtual space image viewed by the user,
a gazing identification part that identifies a gazing time point at which the user viewing the virtual space image gazes at least at a portion of the virtual space image for a predetermined time or longer, on the basis of the display state data,
a feature identification part that identifies a feature manifestation time point that is a point in time at which a specific feature is included in the virtual space image displayed on the information terminal, and
an output part that outputs the gazing time point and the feature manifestation time point in association with each other.

2. The information processing system according to claim 1, wherein
the data acquisition part acquires end data indicating that the user ends viewing the virtual space image, from the information terminal, and
the output part outputs information indicating a viewing end time point indicated by the end data in association with the gazing time point and the feature manifestation time point.

3. The information processing system according to claim 1, wherein
the output part outputs state data indicating a result of estimating a biological state of the user on the basis of the gazing time point and the feature manifestation point.

4. The information processing system according to claim 1, wherein
the feature identification part identifies the feature manifestation time point at which a composition of the virtual space image displayed on the information terminal contains a single-point perspective composition.

5. The information processing system according to claim 1, wherein
the feature identification part identifies the feature manifestation time point including at least one of a type, a size, or a position of guidance information indicating a route along which the user can follow in the virtual space image.

6. The information processing system according to claim 5, wherein
the gazing identification part identifies a point in time at which the user gazes at the guidance information.

7. The information processing system according to claim 6, wherein
when a plurality of pieces of the guidance information are included in the virtual space image, the gazing identification part identifies the guidance information being gazed at for a longer time from among the plurality of pieces of the guidance information.

8. The information processing system according to claim 1, wherein
the feature identification part identifies a proportion of time during which each of a plurality of objects is displayed in the virtual space image within a predetermined time including the gazing time point, and
the output part outputs information indicating the proportion of time in association with the virtual space image.

9. The information processing system according to claim 1, wherein
the output part outputs information indicating a time during which the user continues viewing the virtual space image.

10. The information processing system according to claim 1, wherein
the information processing apparatus further includes a storage that stores an attribute of the user, and
the output part outputs the gazing time point and the feature manifestation time point in association with the attribute of the user.

11. The information processing system according to claim 1, wherein
the output part displays a plurality of images, each showing the gazing time point and the feature manifestation time point in a time sequence manner on the same time axis, the images corresponding to different user viewing durations during which the user continues viewing the virtual space images.

12. The information processing system according to claim 11, wherein
the output part displays information indicating an average viewing duration of the virtual space image overlaid on the plurality of images.

13. The information processing system according to claim 11, wherein
the output part outputs a result of identifying a pattern of manifestation of each of a plurality of features of the virtual space image in which the user viewing duration is longer than an average viewing duration.

14. The information processing system according to claim 13, wherein
the output part outputs, as a result of identifying the pattern of manifestation, an interval between positions at which a specific feature is contained in the virtual space image in which the user viewing duration is longer than an average viewing duration.

15. The information processing system according to claim 11, wherein
the output part outputs an improvement strategy for the virtual space image by using a machine learning model generated through deep learning, utilizing the pattern of manifestation of a plurality of features in a large number of virtual space images in which the user viewing duration is longer than an average viewing duration, as teacher data.

16. The information processing system according to claim 15, wherein
when data indicating a point in time at which one or more specific features are contained in the virtual space image is inputted, the machine learning model outputs data that indicates a point in time, closest to the inputted data, at which the specific feature is contained and the viewing duration is longer than an average viewing duration.

17. An information processing device comprising:
a data acquisition part that acquires display state data for identifying a virtual space image, viewed by a user, in which a displayed region and a displaying orientation are changed by an operation of the user;
a gazing identification part that identifies a gazing time point at which the user gazes at least at a portion of the virtual space image for a predetermined time or more;
a feature identification part that identifies a feature manifestation time point that is a point in time at which specific feature is contained in the virtual space image displayed on the information terminal used by the user; and
an output part that outputs the gazing time point and the feature manifestation time point in association with each other.

18. An information processing method, executed by a computer, the method comprising the steps of:
acquiring display state data for identifying a virtual space image, viewed by a user, in which a displayed region and a displaying direction are changed by an operation of the user;
identifying a gazing time point at which the user gazes at least at a portion of the virtual space image for a predetermined time or longer;
identifying a feature manifestation time point at which specific feature is contained in the virtual space image displayed on the information terminal used by the user; and
outputting the gazing time point and the feature manifestation time point in association with each other.
